(19) United States
(12) Patent Application Publication
(10) Pub. No.: US 2009/0014249 A1
(43) Pub. Date: Jan. 15, 2009

(54) Levitation and Propulsion Unit (LPU)

(76) Inventor: Soon Seng Sin, Toa Payoh (SG)

Correspondence Address: SIN SOON SENG;Blk 222 Lorong 8, Toa Payoh # 18-699, Toa Payoh, 310222, SG

(21) Appl. No.: 11/920,964

(22) PCT Filed: Mar. 14, 2006
(86) PCT No.: PCT/SG06/00055

§ 371 Date: Nov. 23, 2007

(30) Foreign Application Priority Data
Feb. 21, 2006 (SG) 200601086-2

(51) Int. Cl. F03G 3/08

(52) U.S. Cl. 185/27; 244/171.5

(57) ABSTRACT

The Levitation and Propulsion Unit (LPU) defies the pull effect of gravity through the transformation of centrifugal force from spinning wheel into internal upward thrust without interaction with its external environment. It transforms the centrifugal force from spinning wheel by exerting balanced pulsating force parallel to the axis of spin, and reinforce by the compression and expansion of magnetic repulsive force, to create the internal upward thrust parallel to the axis of spin. Through systematic rapid succession of thrust, it counteract the pull effect of gravity, result in levitation; and by angulations of LPU propel the whole unit and its application. It serves to replace or complement the propeller, wheel, jet engine, solid fuel, etc, in the area of transportation and use in space travel.

The Levitation and Propulsion Unit (LPU) defies the pull effect of gravity through the transformation of centrifugal force from spinning wheel into internal upward thrust, without interaction with its external environment. Through the systematic regulation of balanced pulsating force, exerting on each spinning flywheel connected to the top of a spinning main wheel, and reinforce by the compression and expansion of magnetic repulsive force. Synchronise with the systematic regulation of spin rate of each main wheel. Transforms the centrifugal force generated by the main wheel into internal upward thrust due to the design of this invention. The systematic rapid succession of thrust counteract the pull effect of gravity, result in levitation; and by angulations of LPU propel the whole unit and its application.

Therefore, with no need to interact with its environment, this invention can replace or complement the propeller, wheel, jet engine, solid fuel, etc, in the area of transportation and use in space travel.

The following attached drawings support the description and claims, and are part of this submission.

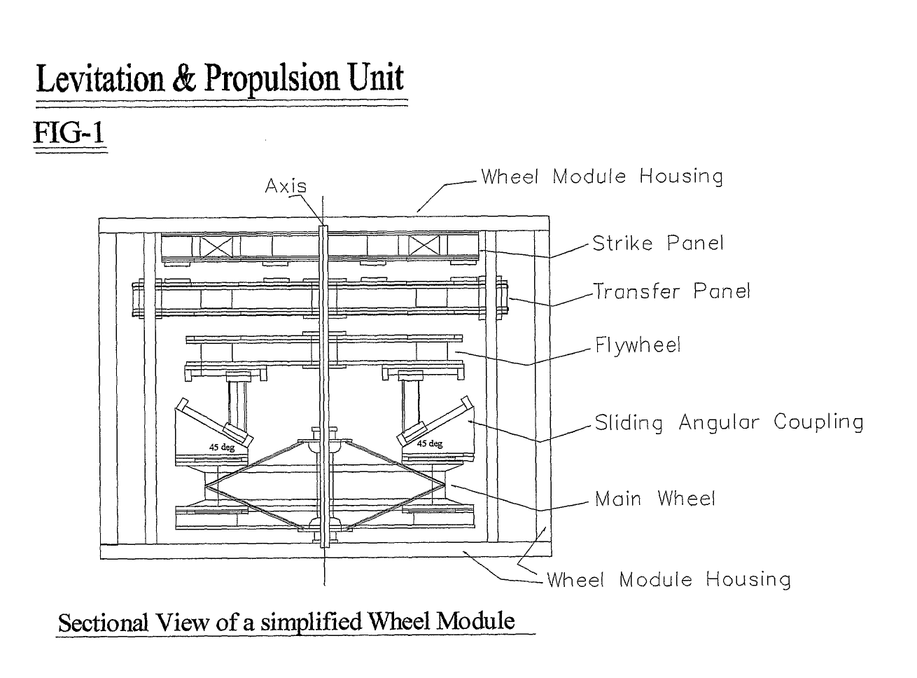

FIG. 1 Sectional view of a simplified Wheel Module.

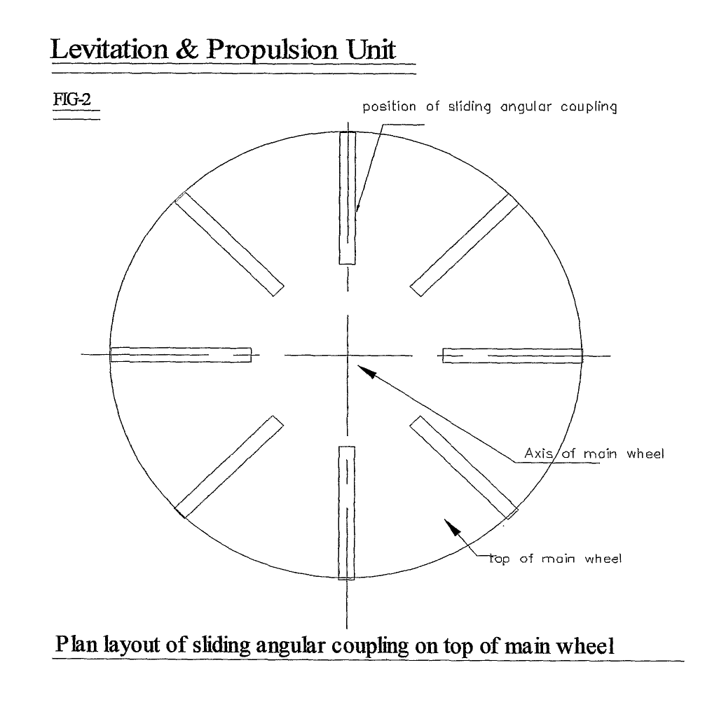

FIG. 2 Plan layout of sliding angular coupling on top of main wheel.

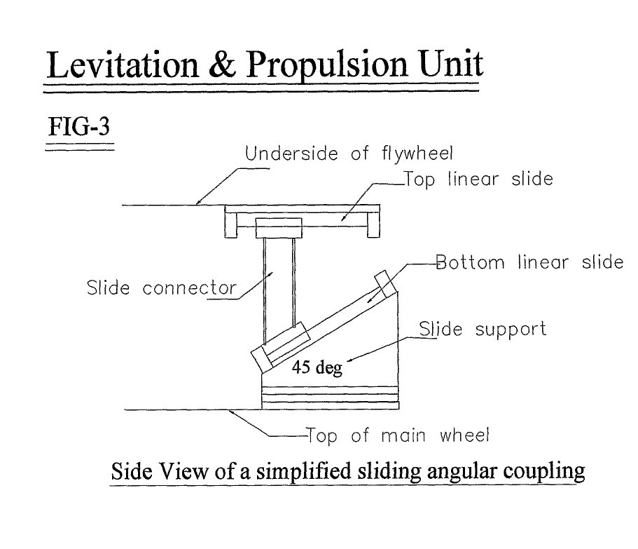

FIG. 3 Side view of a simplified sliding angular coupling.

### BASIC OPERATING SYSTEM

The design of this LPU invention defies the pull effect of gravity. It makes use of spinning wheel to create centrifugal force and transform the force to upward thrust to lift the dead and live weight. A minimum of two wheel modules make up a LPU. The second module is primarily to systematically counteract or balance the torque created by the first main wheel.

In each wheel module, the system operates by exerting a downward force from the strike panel by energising the electromagnets to create magnetic repulsive force on the transfer panel. It in turn transfers the exerted force to the flywheel. The sliding angular couplings that connect the underside of the flywheel to the top side of each main wheel then carry the exerted force to the main wheel. Before the main wheel spin, the point of exerted force transfer is at the lower end of the sliding angular coupling, closer to the axis of spin.

Once the main wheel starts to spin it generates centrifugal force. The strength of the centrifugal force depends on the spin rate and the exerted force on the sliding angular couplings. This centrifugal force pushes the point of exerted force further away from the axis of spin and up the slide, as the spin rate increases. This exerts an upward thrust and pushes the flywheel upward further compressing the magnetic repulsive forces between the flywheel and transfer panel, which in-turn pushes the transfer panel against the strike panel. This further compresses the magnetic repulsive force between these two panels. The further compression of repulsive force, create a build-up of potential energy between flywheel, transfer panel and strike panel.

Through the change in polarity in the electromagnets, the exerted repulsive force changes to attraction force. This releases the potential energy and converts it to upward thrust. The systematic and cyclical change of polarity energizing the electromagnets that pushes down the transfer panel and flywheel in one phase of the cycle. Attract the transfer panel in the next phase of the cycle. This reinforces the upward thrust created by the centrifugal force, and thrusts the unit altogether. The rapid repetition of cycle and systematic control of spin rate in each wheel module will result in levitation; and by angulations, propel the LPU and its load.

Alternatively, the system can operates with the main wheel spinning, generating centrifugal force before energising the electromagnets to create the exerted force.

### Composition of Invention

The Levitation and Propulsion Unit CPU) comprises mainly of a minimum of two numbers variable speed spinning main wheels, each spinning in opposing direction, with vertical pulsating spinning flywheel connected at top of each main wheel with sliding angular couplings. It also includes a series of variable frequency electromagnets to exert a vertical pulsating effect on each spinning flywheel.

The main components in each wheel module, herein named as, are a main wheel, sliding angular couplings, flywheel, transfer-panel, strike panel with electromagnets and its wheel module housing, see FIG. 1. Each LPU has an on-board control module.

Within each wheel module housing, a central fixed shaft spans vertically from the bottom panel of the module housing to the top panel. The main function of this shaft besides providing structural stability, serves to pivot the main wheel and flywheel, serve as the centre guide for the transfer panel, and is the axis of each module. The core of this shaft can be hollow to serve as conduit for utilities.

The main wheel can be of material suitable to meet the LPU usage requirement. Similarly, the size, construction and configuration of the main wheel can vary to meet the spin rate of the wheel, the torque generator requirement, usage requirement, etc. The torque generation on the wheel can be by electromagnet or by pneumatic means, internal combustion system, or any suitable torque generation method to meet usage requirement. The main function of this main wheel is to generate centrifugal force through spinning.

On top of each main wheel are the sliding angular couplings arranged in radial pattern with the higher side in line with the circumference of the main wheel and the low end directed toward the axis of the wheel, see FIG. 2. At each coupling, the sliding devices can be of any appropriate low fiction linear slide or other type of similar devices with ends stopper to prevent overrun, see FIG. 3. One slide is mainly angled 45 degree on the top side of the main wheel, away from the axis of the main wheel. The length of each slide and the angulations will depend on the LPU usage requirement. The configuration and number of this sliding angular coupling similarly depend on the main wheel size, its configuration and the LPU usage requirement. The main function of this sliding angular coupling is to transfer the exerted force to the main wheel and transform the centrifugal force to upward force.

Sliding angular couplings connect the flywheel to the main wheel. The flywheel comprises mainly of a circular construction with top side lined with permanent magnets, ring magnets or electromagnets to repel the magnetic flux from the transfer panel magnets. The size and configuration of the flywheel, and the number and arrangement of magnets lined on the top side will depend on the LPU usage requirement. The flywheel spins together with the main wheel and slide accordingly on the centre shaft. The main function of the flywheel is to transfer the exerted force to the sliding angular couplings and transfer the upward force from the couplings to the transfer panel.

The transfer panel is a non-spin panel that slide along the central shaft and side shafts. The transfer panel comprises mainly of a rigid panel with cover plate on both sides to hold permanent magnets, ring magnets or electromagnets lined on both sides. On the top side of the transfer panel are impact elements to thrust the strike panel. The transfer panel size, configuration and magnets arrangement depend on the flywheel and strike panel. The main function is to transfer the exerted force to the flywheel and deliver the upward thrust on the strike panel.

The strike panel connected to each module housing structure comprises mainly of a rigid panel with openings to hold the series of electromagnets and impact elements to receive the impact. Its size, configuration and arrangement of electromagnets will depend on the LPU usage requirement. The main function is to repel or attract the transfer panel and to lift the module.

The wheel module housing can be an open or close structure depending on usage requirement. It must be adequate to contain the components and withstand the forces generated within. Bracing and mounting plates integrate each wheel module to make up the whole LPU; and secure the LPU to its load.

The control module synchronises and regulates the electromagnets and the spin rate of the main wheel. It comprises mainly of electronic circuits, weight sensors, and other sensors complete with circuit to integrate additional LPU and external control.

The usage requirement and size of the LPU will mainly determine the material and construction of each component, beside its functional requirement. Similarly, the size, arrangement and the use of permanent magnets, ring magnets or electromagnets in components need to meet the usage requirement and size of the LPU, as well.

### Usage of Invention

Levitation and Propulsion Unit allows variation in application. It main design function is levitation and propulsion. By mounting it horizontally with the module axis vertical, it functions as levitation unit. By varying the angle of module axis and accordingly increases the spin rate, it function as a propulsion unit.

Installation of Levitating and Propulsion Unit (LPU) can be singular or multiple unit, enlarge or reduce in size to meet the load, integration or usage requirement. It usage is mainly in transportation, to allow three-dimensional movement, or use to reduce load weight together with other transportation system; and in the area of space travel.

1. A device, herein named as Levitation and Propulsion Unit (LPU), as reflected in its description and drawings. Which comprises of, mainly, a minimum of two, herein named as wheel modules, its mounting and bracing plates and a control module. Of which each wheel module comprises of main components, herein named as, main wheel, sliding angular couplings, flywheel, transfer panel, strike panel and module housing. The material of which is, mainly or in part of, titanium or its alloys, aluminium or its alloys, magnesium or its alloys, steel or its alloys, ferrous or non ferrous metals or its alloys, plastic or its compound, rubber or its compound, or combination of material, or composite.
The main features, among others, in the wheel module of the device being:
a) The layout of main components in the wheel module. The layout from bottom up is, main wheel, sliding angular couplings, flywheel, transfer panel and strike panel.
b) The main function of each main component being:
i) Main wheel—to generate centrifugal force through spinning.
ii) Sliding angular coupling—to transfer the exerted force from the flywheel to the main wheel; and to convert or transform the centrifugal force generated into upward force, parallel to axis of spin; and transfer it to the flywheel.
iii) Flywheel—to transfer the exerted force to sliding angular couplings; and transfer the upward force from the couplings to transfer panel.
iv) Transfer panel—to transfer the exerted force onto the flywheel; and deliver the upward thrust onto the strike panel.
v) Strike panel—to repel; and attract the transfer panel; and to receive the thrust from the transfer panel to lift the module.
c) The use of electromagnetic flux as the exerted force on the transfer panel, parallel to the module axis.
d) The use of magnetic repulsive force as medium between flywheel and transfer panel, and between transfer panel and strike panel, as a medium similar to gas, to transfer and enhance the exerted force to, and the thrust from, the main wheel.
e) The transformation of centrifugal force from spinning wheel into upward thrust, without interaction from its external environment, i.e. Air, water, surface, or mixture of which, vacuum, space outside the confine of planet “Earth” or outer space, medium outside the craft fitted with the device to meet the device usage requirement.

2. A device of claim 1 wherein the main wheel in the wheel module is a disc; disc with thick edge or thick rim; circular plate; circular plate with thick edge or thick rim; wheel; circular frame or ring with radial spokes, rods, cables, arms, disc, panes or combination; oval; saucer; rotor pane; arm; or combination of earlier stated configuration. And the main wheel come together with electromagnet and magnet; magnet, pneumatic; hydraulic; internal/external combustion system; nuclear or similar power system; jet turbine or jet power system; battery power system; electro-mechanical; human power electrical or mechanical; electrical induction; laser system; or combination of earlier stated, drive connection, drive attachment or both.

3. A device of claim 1 & 2 wherein there is more than one main wheel in the wheel module interconnected and positioned one above each other, next to each other or both.

4. A device of claim 1, 2 & 3 wherein there is one or more panels completes with magnetic element to develop magnetic repulsive force, included in between the flywheel and transfer panel.

5. A device of claim 1, 2 & 3 wherein gas or gases, oil, liquid or compound, spring or mechanism, or combination, are used in between the flywheel and transfer panel; or the additional panel as in claim 4, in the wheel module instead of magnetic repulsive force. In which, no magnetic element included on the flywheel and the panel side facing it. Instead, attachment, containment, enclosure, cylindrical chamber, or combination, included on the flywheel; and close or open attachment, containment, enclosure, cylindrical chamber, or combination, included on the immediate panel, which slides within the chamber.

6. A device of claim 4 & 5 wherein gas or gases, oil, liquid or compound, spring or mechanism, or combination, are used in between additional panels, or additional panel with the transfer panel, in the wheel module, instead of magnetic repulsive force. In which, no magnetic element included on each side of both panels. Instead, attachment, containment, enclosure, or cylindrical chamber included on one panel; and close or open attachment, containment, enclosure, cylindrical chamber, or combination, included on the immediate panel or transfer panel, which slides within the chamber.

7. A device of claim 1, 2 & 3 wherein the flywheel directly impacts the strike panel or top panel of module housing instead of the transfer panel or strike panel. There is no transfer panel or strike panel or both in the wheel module.

8. A device of claim 1 to 6 wherein there is no cover plate on one or both sides of the transfer panel.

9. A device of claim 1 to 6 & 8 wherein the exerted force or vertical “on/off” force at the strike panel of the wheel module, act on the transfer panel or on flywheel of claim 7. Generated by a system of, cam or rocker, or both mechanism with linkage or connection connected to torque generator or drive connection of the main wheel. Or cam or rocker, or both mechanism with linkage or connection connected to component of the craft, or motorised cam or rocker, or both, harmonic system; gas or gases system; internal or external combustion system; or pneumatic/hydraulic/electric piston; or combination of earlier stated, instead of electromagnetic mean.

10. A device of claim 1 to 9 wherein the system or application of the exerted force is above the strike panel; or on the module housing top panel in which no strike panel is included in the wheel module.

11. A device of claim 1 to 10 wherein there is more than one system or application of the exerted force in “V” or parallel arrangement to the module axis, above the strike panel or transfer panel without strike panel.

12. A device of claim 1 to 11 wherein the stated minimum two wheel modules, the spin direction of the main wheels is not opposing.

13. A device of claim 1 to 11 wherein there is only one wheel module.

14. A device of claim 1 to 13 wherein the whole layout of main components inside the wheel module is in 180 degree rotated arrangement, and function to create internal downward force, or “weight” or “gravity” inducement, instead of internal upward force.

15. A device of claim 1 to 13 wherein it enables orientation or tilting, angular or horizontal mounting of single or multiple wheel modules for it to function as a levitation, propulsion or steering unit, or two of the stated function, or all three function.

16. A device of claim 14 and 15 wherein it functions include levitation, propulsion, steering, and “weight” or “gravity” inducement.

17. A device of claim 1 to 16 wherein it enables the control of the exerted force to operate in run, off and hold mode,
i.e. run—the flywheel move up & down in rapid cycle,
off—the flywheel in up position;
hold—the flywheel in down position.

18. A device of claim 17 wherein the sliding angular coupling, the bottom linear slide is not at 45 degree angle. Instead, various angulations or adjustable angulations or both, not exceeding 90 degree included.

19. A device of claim 18 wherein each wheel module is arrange on top or above each other, or/and on same or different plane or axis to each other or combination.

20. A device, a craft or the components of the craft of claim 19 wherein the main components of the wheel module are sufficiently enlarge to accommodate man, cargo or equipment; or combination of which; or all as stated, within or around the components layout. The module housing than take the form of a spinning outer shell or enclosure connected to the main wheel in which the shell spin in opposing direction to the main wheel. The device or craft function via the systematic regulation of spin rate between the outer shell and main wheel, and the exerted force at or above the strike panel. Other wheel modules serve to complement the device or craft function.

21. The configuration, design or the device of sliding angular coupling that convert or transform centrifugal force to vertical force, or force parallel to the axis of spin as in claim 1 to 20. Each coupling comprises of a fix or adjustable, or both angular slide support, two linear slides or fabricated linear sliding device and slide connector.

22. The device of claim 21 together with the flywheel, which uses magnetic repulsive force, gas or gases, oil or liquid compound to interact with the next medium. To convert or transform spinning force/centrifugal force to vertical force or force parallel to the axis of spin, as in claim 1 to 20.
